(19) United States
(12) Patent Application Publication
(10) Pub. No.: US 2009/0241005 A1
(43) Pub. Date: Sep. 24, 2009

(54) METHOD FOR PACKET SCHEDULING IN SELECTIVE HYBRID ARQ

(76) Inventors: Tae-Chul Hong, Daejon (KR); Kun-Seok Kang, Daejon (KR); Do-Seob Ahn, Daejon (KR); Ho-Jin Lee, Daejon (KR)

Correspondence Address: STAAS & HALSEY LLP, SUITE 700, 1201 NEW YORK AVENUE, N.W., WASHINGTON, DC, 20005, US

(21) Appl. No.: 12/442,020

(22) PCT Filed: Sep. 21, 2007
(86) PCT No.: PCT/KR07/04648

§ 371 Date: Mar. 19, 2009

(30) Foreign Application Priority Data
Sep. 21, 2006 (KR) 10-2006-0091985

(51) Int. Cl. H04L 1/18; G06F 11/14

(52) U.S. Cl. 714/749; 714/E11.113

(57) ABSTRACT

There is provided a method for packet scheduling in a selective hybrid automatic repeat request (HARQ) including the steps of: increasing a priority of a receiver buffer after a packet is transmitted to the receiver; receiving a feedback packet for the transmitted packet and determining whether the feedback packet is an ACK packet or a NACK packet; lowering the priority of the receiver buffer if the feedback packet is an ACK packet; determining whether the feedback packet is a NACK packet for initial transmission or the feedback packet is a NACK packet for retransmission if the feedback packet is the NACK packet, increasing the priority of the receiver buffer if the feedback packet is the NACK packet for the initial transmission, and lowering the priority of the receiver buffer if the feedback packet is the NACK packet for retransmission; and scheduling packets after calculating a priority of each receiver buffer by performing the priority increasing step to the determining step for all of receivers.

### TECHNICAL FIELD

The present invention relates to a method for packet scheduling in a selective hybrid automatic repeat request (HARQ) system; and, more particularly, to a method for packet scheduling in a selective HARQ system, which can improve the overall reception rate of a system by lowering a scheduling priority of a receiver having a higher chance of generating buffer overflow error due to error packets in a system having a long round trip time, which corrects the error of a packet by combining HARQ type II or HARQ type III and selective ARQ.

This work was partly supported by the Information Technology (IT) research and development program of the Korean Ministry of Information and Communication (MIC) and/or the Korean Institute for Information Technology Advancement (IITA) [2005-S-014-02, “Development of satellite IMT-2000+technology”] and the National Research Laboratory (NRL) program of the Korean Ministry of Science and Technology (MOST)/the Korea Science and Engineering Foundation (KOSEF) [2005-S-014-02, “Development of satellite IMT-2000+technology”].

### BACKGROUND ART

Throughout the specification, a satellite communication system is described as a system having a long round trip time. However, the present invention is not limited thereto.

In general, hybrid automatic repeat request (HARQ) is a method for correcting packet errors by combining forward error correction (FEC) and automatic repeat request (ARQ).

The FEC is a technology for receiving accurate information by correcting error generated in a wireless channel using an error correcting code. The ARQ is a technology for receiving a packet again from a transmitter by requesting the transmitter to retransmit a packet at a receiver if error occurs in a wireless channel. The ARQ include selective ARQ.

Therefore, hybrid ARQ (HARQ) prevents error generation using an error correcting code and retransmits a packet through ARQ if the error correction is impossible.

Three types of HARQ were introduced.

At first, the HARQ type I is a method for retransmitting the same packet if it is impossible to correct the error of a wireless channel using an error correcting code.

The HARQ type II is a method for transmitting a packet constituted of a parity bit of an error correcting code instead of retransmitting the same packet like the HARQ Type I if error occurs in a wireless channel. Such a method is referred as an Incremental Redundancy (IR) method. The IR scheme lowers the chance of error generation in a retransmission process by improving the correction ability of an error correcting code.

Finally, the HARQ type III is a method for transmitting a data bit, an initially transmitted parity bit, and another parity bit if it is impossible to correct the error of a wireless channel using an error correction code.

It may be difficult to correct error using a parity bit if the data is seriously damaged in initial transmission using the HARQ Type II. The HARQ Type III can advantageously correct error by retransmitting data and parity together although the data part of the initial packet is seriously damaged.

Since the HARQ Type III transmits another parity bit that is different from the initially transmitted parity bit unlike the HARQ Type I, a receiver can improve the error correction ability of an error correcting code by collecting the received parities. However, the HARQ Type II is the most effective method to improve the error correction ability through retransmission.

Such a HARQ has been employed by the most of mobile communication systems after 3 generation (3G). Especially, the IR method of the HARQ Type II was generally employed. However, the HARQ Type II and the HARQ Type III require a receiver to have a receiving buffer unlike the typical ARQ and the HARQ Type I.

That is, the typical ARQ or the HARQ Type I request a transmitter to retransmit packets and discard the received error packet if errors occur in a wireless channel. On the contrary, the HARQ Type II and the HARQ type III store the initially received error packets to decode retransmitted packets by combining the stored error packets with the retransmitted packets. Therefore, the receiver must have sufficient buffer. For example, a receiver generally needs a receiving buffer as large as the multiplication of the maximum number of packets transmittable in a round trip time with maximum retransmission times when the selective ARQ is used.

Since the complexity of a physical layer increases according to the size of a buffer, the most of mobile communication systems generally use a stop-and-wait (SAW) ARQ with HARQ after 3G.

However, a transmit rate is limited in the SAW ARQ although the size of a receiving buffer can be reduced and the complexity can be also lowered using the SAW ARQ. In order to overcome the shortcomings, N-channel SAW ARQ was introduced. The N-channel SAW ARQ uses an automatic repeat request (ARQ) in N channels. Therefore, the N-channel SAW ARQ has a reception rate that is N times higher than that of the SAW.

The HARQ combined with the N-channel SAW effectively operates in a ground system.

However, a bandwidth may be wasted if the N-channel SAW is used in a system having a long round trip time, such as a satellite. For example, a round trip time of a geostationary orbit transponder is about 0.5 second. If the geostationary orbit transponder employs the N-channel SAW, the geostationary orbit transponder does not transmit frames as many as Eq. 1. Accordingly, the bandwidth is wasted.

Time of not transmitting frames=0.5−length of a frame×N Eq. 1

In Eq. 1, N denotes the number of channels.

On the contrary, if N is set significantly large, the complexity may increase like the selective ARQ. Also, it is not easy to properly control the buffer size of a receiver because it cannot predict how many users will communicate at once for data communication.

Therefore, if a round trip time is great, it is effective to use the selective ARQ with a comparative smaller receiving buffer for performing data communication. In this case, error packets may be generated due to the overflow of a buffer in a receiver. The IR method of the HARQ may continuously generate packet error and significantly degrade the system reception rate if erroneous data packets are not stored.

### DISCLOSURE

### Technical Problem

An embodiment of the present invention is directed to providing a method for packet scheduling in a selective hybrid automatic repeat request (HARQ) system, which can improve the overall reception rate of a system by lowering a scheduling priority of a receiver having a higher chance of exceeding a storage capacity of a buffer due to error packets in a system having a long round trip time that corrects the error of a packet by combining HARQ type II or HARQ type III and selective automatic repeat request (ARQ).

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method for packet scheduling in a selective hybrid automatic repeat request (HARQ) including the steps of: increasing a priority of a receiver buffer after a packet is transmitted to the receiver; receiving a feedback packet for the transmitted packet and determining whether the feedback packet is an ACK packet or a NACK packet; lowering the priority of the receiver buffer if the feedback packet is an ACK packet; determining whether the feedback packet is a NACK packet for initial transmission or the feedback packet is a NACK packet for retransmission if the feedback packet is the NACK packet, increasing the priority of the receiver buffer if the feedback packet is the NACK packet for the initial transmission, and lowering the priority of the receiver buffer if the feedback packet is the NACK packet for retransmission; and scheduling packets after calculating a priority of each receiver buffer by performing the priority increasing step to the determining step for all of receivers.

### ADVANTAGEOUS EFFECTS

A method for packet scheduling in a selective hybrid automatic repeat request (HARQ) system according to an embodiment of the preset invention can improve the overall reception rate of a system by lowering the scheduling priority of a receiver having a high probability of generating buffer overflow error due to error packet in a system having a long round trip time, which corrects the error of a packet by combining HARQ type II or HARQ III and selective ARQ.

Also, the packet scheduling method according to an embodiment of the present invention can estimate a probability of buffer overflow errors and reflect the estimated probability to a scheduling function in real time.

Furthermore, the packet scheduling method according to an embodiment of the present invention can improve a reception rate of a system as a receiver buffer is small.

Moreover, the packet scheduling method according to an embodiment of the present invention can improve the performance of a conventional scheduler by applying the packet scheduling method with a scheduling function of a conventional packet scheduler.

### BRIEF DESCRIPTION OF THE DRAWINGS

FIG. 1 is a diagram of a satellite communication system where the present invention is applied.

FIG. 2 is a diagram showing a state transition of a receiver buffer in accordance with an embodiment of the present invention.

FIG. 3 is a diagram depicting a state of transmitting packets for round trip time in accordance with an embodiment of the present invention.

FIG. 4 is a flowchart of a method for packet scheduling in a selective hybrid automatic repeat request system in accordance with an embodiment of the present invention.

FIG. 5 is a diagram showing a queue of a transmitter in a satellite communication system where the present invention is applied.

FIG. 6 is a graph illustrating a simulation result for an overall system reception rate in accordance with an embodiment of the present invention.

FIG. 7 is a graph showing a simulation result for the number of overflow errors in a receiver buffer in accordance with an embodiment of the present invention.

FIG. 8 is a graph depicting a simulation result for reception rates per users in accordance with an embodiment of the present invention.

### BEST MODE FOR THE INVENTION

The advantages, features and aspects of the invention will become apparent from the following description of the embodiments with reference to the accompanying drawings, which is set forth hereinafter. Throughout the specification, a method for packet scheduling in a selective HARQ system according to an embodiment of the present invention will be described to be applied to a satellite system environment. However, the method for packet scheduling according to an embodiment of the present invention can be identically applied to a terrestrial mobile communication system that forms a cell based on a base station.

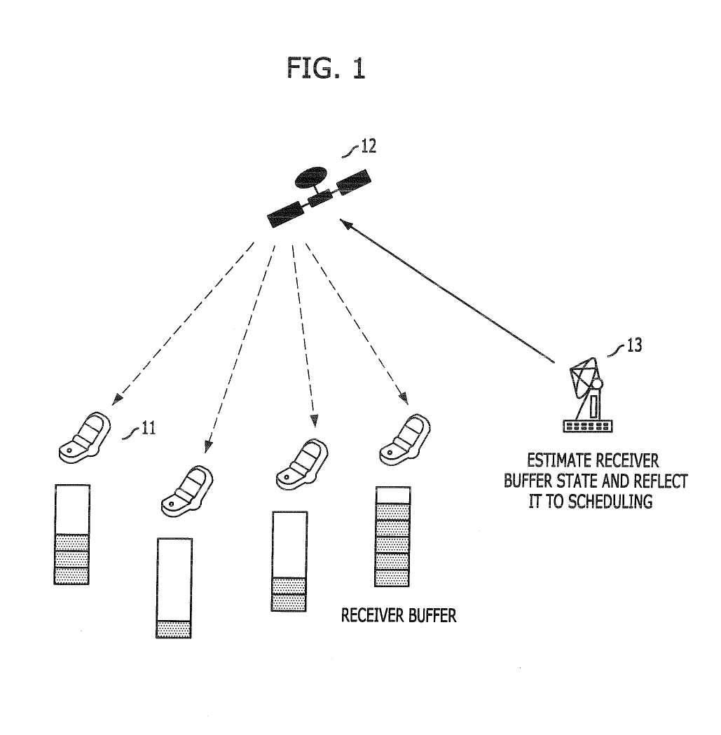

FIG. 1 is a diagram of a satellite communication system where the present invention is applied. That is, FIG. 1 illustrates four receivers 11 performing data communication using a satellite transponder 12.

As shown in FIG. 1, since the receivers 11 may be located at various environments in satellite communication, a radio channel difference between the receivers 11 is great.

Therefore, each of the receivers 11 may have different error generation frequency according to a radio channel environment although the receivers 11 have the same size of buffers. Therefore, each of the receivers 11 may have a different state of occupying a buffer.

A ground control system 13 estimates the buffer state of each receiver 11 through the satellite transponder 12 and performs data communication based on the estimated buffer state.

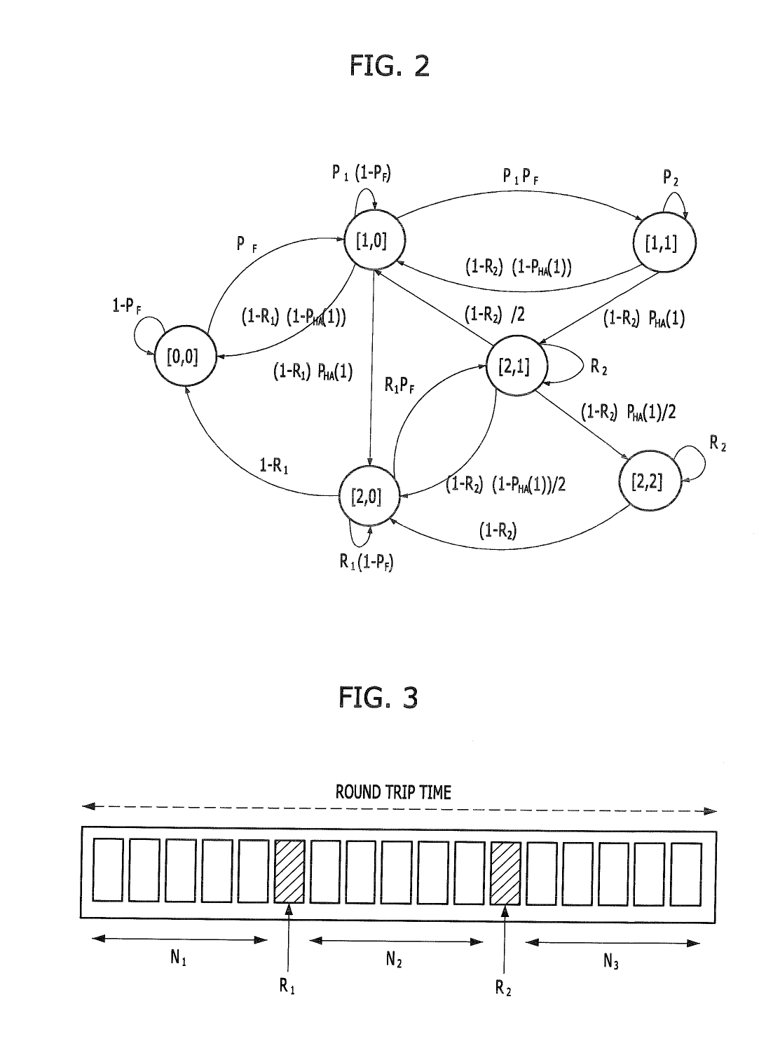

FIG. 2 is a diagram showing a state transition of a receiver buffer in accordance with an embodiment of the present invention. In FIG. 2, the state transition is described with a receiver buffer capable of processing two packet errors.

At first, [0,0] denotes a state of an empty buffer. [1.0] means a state of a buffer storing one error packet generated from initial transmission. [2,0] represents a state of a buffer storing one error packet generated from retransmission. [1,1] denotes a state of a buffer storing two error packets generated from initial transmission. [2,1] means a state of a buffer storing an error packet generated from retransmission and an error packet generated from initial transmission. [2,2] shows a state of storing two error packets generated from retransmission. [1,1], [2,1], and [2,2] denote states for not storing new error packet.

Therefore, if a buffer in [0,0] stores one error packet, the state of the buffer transits to [1,0]. Then, the error caused by the error packet is recovered, the state of the buffer transits to [0,0] again. But, if error occurs in retransmission, the state of the buffer transits to [2,0].

In FIG. 2, PF denotes a frame error probability or a packet error probability. PHA(1) denotes a frame error probability after first retransmission. It is assumed that the maximum retransmission time is 3.

If N is defined as smaller one between a window size of selective ARQ and the number of packets transmittable in a round trip time, R1 is (N−1)/N and R2 is (N−2)/N.

If the accurate probabilities of PF and PHA(1) are known, a state probability can be calculated through the state transition diagram as shown in FIG. 2. That is, a probability of overflowing a buffer in a receiver can be calculated based on the state probabilities of [1,1], [2,1], and [2,2].

However, it is difficult to accurately obtain the state probabilities and the buffer overflow probability because PF and PHA(1) do not have constant values, that is, because the values of PH and PHA(1) change according to situations.

In addition, although the statistical probability can be calculated through the state transition diagram, it is difficult to calculate the buffer overflow probability of a receiver in real time. It is because the buffer overflow probability dynamically changes while packets are transmitting.

FIG. 3 is a diagram depicting a state of transmitting packets for round trip time in accordance with an embodiment of the present invention.

In order to calculate a buffer overflow probability of a receiver buffer in real time, it is assumed that a receiver buffer is capable of processing two error packets and two error packets are currently retransmitted because two errors are generated.

Referring to FIG. 3, R1 and R2 denote retransmit packets, N1 represents packets transmitted before the retransmit packet R1, and N2 denotes packets transmitted between the retransmit packets R1 and R2. N3 represents packets transmitted after the packet R2 is transmitted.

It is not simple to calculate a probability of buffer overflow in a receiver buffer under such conditions. At first, if a packet error occurs among packets N1, the overflow error will occur in a receiver buffer. Then, the overflow probability may depend on whether the error of the error packet the receiver buffer is corrected or not by retransmitting the packet R1.

If the error is corrected by retransmitting the packet R1, the buffer can store one more error packet at a time of transmitting the packets N2. Therefore, if more than two errors occur among the packets N2, the overflow error occurs in the receiver buffer.

On the contrary, if the error correction of the packet R1 is failed and one error occurs among the packets N2, the overflow error will occur in the receiver buffer.

Meanwhile, the buffer overflow error may occur in diverse cases, for example, total eight cases, in a period of transmitting the packets N3 by the influence of the packets R1, N1, and R2. For example, the buffer overflow may occur in four cases related to the failure and the succession of the error corrections of the packets R1 and R2, in one case related to the generation of packet error in one of the packets N1, and in two cases of not generating a packet error in one of the packets N1.

Therefore, it is very difficult to calculate and reflect the overflow error of buffers of receivers, which can store N error packets, in real time in a view of system complexity.

In order to overcome such difficulty, the trend of buffer overflow errors of receivers is calculated through a buffer priority update method and the calculated trend is reflected into packet scheduling in stead of calculating the actual receiver buffer overflow error in the present embodiment. That is, if a probability of generating a receiver buffer overflow error is high, a priority of scheduling is lowered.

It will be described in more detail hereinafter.

BPᵢ denotes a buffer priority representing a probability of generating the buffer overflow error of the i^{th} receiver. The priority of a buffer is updated like Eq. 2 according to the operation of a HUB. That is, when the HUB transmits a packet to the i^{th} receiver, the priority of a receiver buffer is updated like Eq. 2.

BPᵢ=BPᵢ+PF×SF Eq. 2

PF denotes a packet error probability, and scaling factor (SF) has a real number. That is, if one packet is transmitted, a packet error probability is a rate as much as SF, thereby increasing the priority of a receiver buffer.

When the HUB receives ACK from the i^{th} receiver, the HUB updates the priority of a receiver buffer like Eq. 3.

BPᵢ=BPᵢ−PF×SF Eq. 3

That is, when the HUB receives ACK, the HUB lowers the buffer priority as much as a value updated when a packet is transmitted in order to inform that a transmitted packet does not occupy a receiver buffer for HARQ.

When the HUB receives NACK from the i^{th} receiver, the HUB updates the priority of a receiver buffer like Eq. 4.

BPᵢ=BPᵢ+FNV Eq. 4

That is, if the HUB receives NACK, the HUB increaseS the priority of the receiver buffer as much as a First Nack Value (FNV) in order to inform that a transmitted packet does occupy a receiver buffer for HARQ. The FNV has a real number.

Meanwhile, when the HUB receives ACK from retransmit packet from the i^{th} receiver, the HUB updates the priority of a receiver buffer like Eq. 5.

BPᵢ=BPᵢ−RAV Eq. 5

That is, the HUB reduces the priority of a receiver buffer as much as a retransmit ACK value (RAV) in order to inform that a receiver buffer reduces one packet for hybrid repeat request of a receiver through a transmitted packet when the HUB receives ACK for retransmit packet. The RAV has a predetermined real number.

A HUB updates the priority of a receiver buffer like Eq. 6 if the HUB receives NACK for a retransmit packet from the i^{th} receiver.

BPᵢ=BPᵢ−RNV Eq. 6

When the HUB receives NACK for a retransmit packet, the HUB lowers the priority of receiver buffer as much as a retransmit NACK value (RNV). That is, when the HUB receives NACK for a retransmit packet, the HUB lowers the priority of a receiver buffer as much as PF×SF like Eq. 2 because a state of occupying a receiver buffer for HARQ of a receiver through transmitted packet is not changed. However, since the NACK packet for retransmit packet informs that states of transmission channels are seriously unstable, the HUB increases the priority of a receiver buffer as much as a predetermined real number CH in order to reflect the unstable state of the transmit channel. Therefore, RNV is calculated by PF×SF−CH. If a scheduler reflecting the state of channels is used, CH is set to 0 in order to prevent channel states from reflecting twice to scheduling.

When the HUB receives NACK for transmitted packets from the i^{th} receiver as many as the maximum retransmit times, the HUB updates the priority of a receiver buffer like Eq. 7.

BPᵢ=BPᵢ−MNV Eq. 7

That is, when the HUB receives a NACK packet for the transmission packet as many as the maximum retransmission times, a receiver deletes previously stored packets because it fails to recover packets through the transmitted packet. Therefore, the HUB lowers the priority of a receiver buffer as much as maximum retransmit NACK value (MNV) because a receiver buffer for HARQ increase as many as one packet.

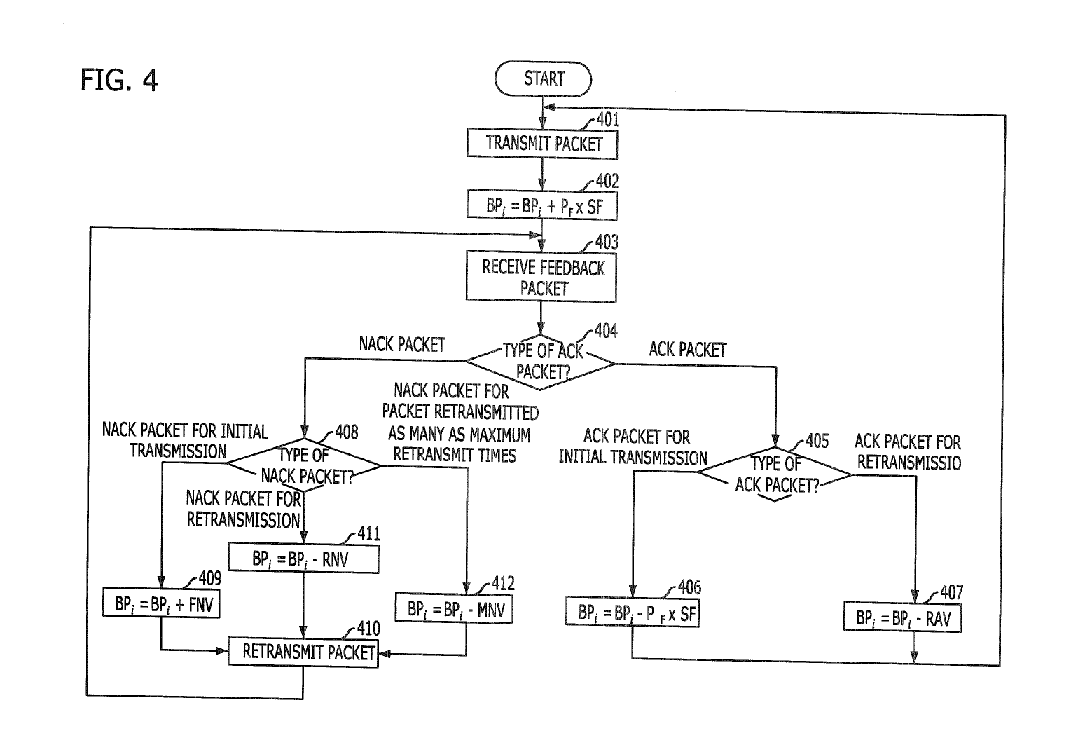

The above described method for updating the priority of a receiver buffer will be described in detail with reference to FIG. 4.

At first, after a packet is transmitted, the priority of a corresponding receiver buffer is updated like Eq. 2 at steps S401 and S402.

Then, when a feedback packet for the transmitted packet is received, it is determined whether the received packet is an ACK packet or an NACK packet at steps S403 and S404.

If the received packet is the ACK packet at step S404, the type of the ACK packet is determined at step S405.

If the received packet is an ACK packet for initial transmission at step S405, the priority of a corresponding receiver is updated like Eq. 3 at step S406.

If the received packet is an ACK packet for retransmission, the priority of a corresponding receiver buffer is updated like Eq. 5 at step S407.

If the received packet is an NACK packet, the type of the NACK packet is determined at step S408.

If the received packet is an NACK packet for initial transmission, the priority of a corresponding receiver buffer is updated like Eq. 4 at step S409.

Then, a corresponding packet is retransmitted and the step S403 is performed at step S410.

If the received packet is an NACK packet for retransmission at step S408, the priority of a corresponding receiver buffer is updated like Eq. 6 at step S411.

Then, a corresponding packet is retransmitted and the step S403 is performed at step S410.

If the received packet is an NACK packet for retransmitted packet as many as the maximum retransmit times, the priority of a corresponding receiver buffer is updated like Eq. 7 at step S412.

Then, a corresponding packet is retransmitted and the step S403 is performed at step S410.

The updated priority of a receiver buffer is reflected to scheduling like Eq. 8.

$$\frac{1}{log ( A + {BP}_{i} )} \qquad Eq . 8$$

In Eq. 8, A is a real number larger than 1.

In order to control the degree of influencing the priority of a receiver buffer to scheduling, a log function is applied to the reciprocal of the updated priority of a received buffer. That is, if the value of A is large enough, it becomes much closer to a scheduling method before the receiver buffer priority is applied, and the effect of applying the receiver buffer priority is shown.

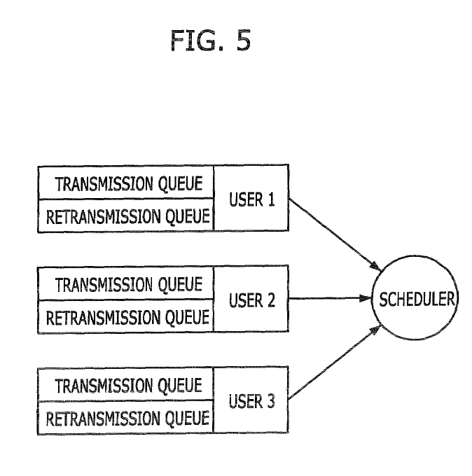

Also, in order to conveniently determine whether an ACK packet or an NACK packet is for initial transmission packet or retransmission packet, two packets queues, a transmission queue and a retransmission queue, can be used as shown in FIG. 5.

Meanwhile, a simulation of applying a packet scheduling method into a proportional fairness scheduler is performed to test the performance of the present invention.

The simulation is performed after five users are distributed at various environments such as urban, suburban, and rural.

Also, it is assumed that the receiver buffers of users can store and correct maximum 10 packet errors and HARQ Type II.

If the packet scheduling method according to the present embodiment is applied to the proportional fairness scheduler, Eq. 9 shows the type of the scheduler.

$$f ( scheduling ) = \frac{{C}_{i} \cdot {G}_{i}}{log ( A + {BP}_{i} ) \cdot {MT}_{i}} \qquad Eq . 9$$

In Eq. 9, Cᵢ denotes a channel state of the i^{th} user, MTᵢ means a mean reception rate of the i^{th} user, and Gᵢ is a gain obtained by applying HARQ for retransmission.

Parameters are applied to the simulation as follows. PF is 0.01, SF is 0.001, RAV, FNV, and RNV is 0.01, and MNV is 10⁻⁵. However, such parameters may be properly modified in consideration of system characteristics when the parameters are applied to a real system.

The initial values of BPᵢ are identically applied as 0.1. It is preferable to reflect a capacity difference of a receiver buffer of each user in case of the initial value of BPᵢ.

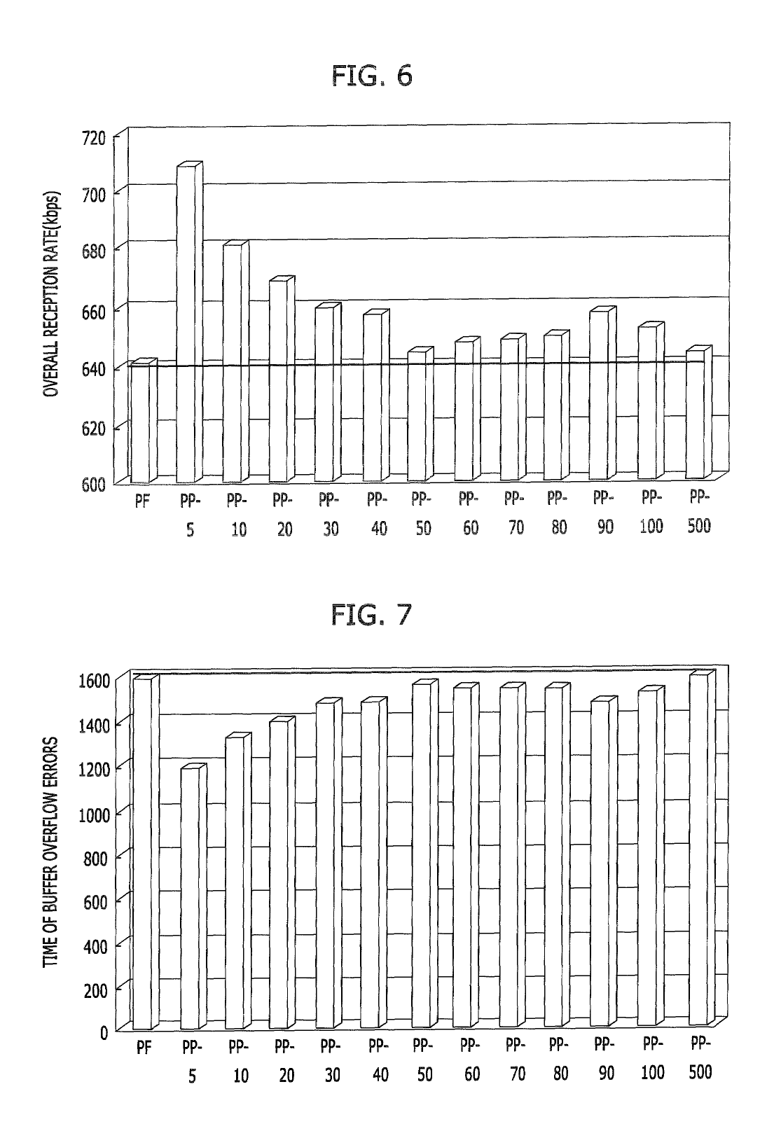

FIGS. 6, 7, and 8 show the result of simulations performed under the above described conditions.

In FIG. 6, ‘PF’ denotes the simulation result of using a general scheduler method with a proportional fairness scheduler, and ‘PP’ denotes the simulation result of using the scheduling method according to the present embodiment. The simulation results are obtained while the value of A changes from 5 to 500. As shown in FIG. 6, the smaller the value of A is, the larger the overall reception rate becomes. That is, the reception rate of a typical proportional fairness scheduler can be improved by reflecting the information of a receiver buffer.

Such a reason of reception rate increment can be confirmed by FIG. 7. That is, the waste of a bandwidth can be reduced by reducing the number of overflow errors in a receiver buffer

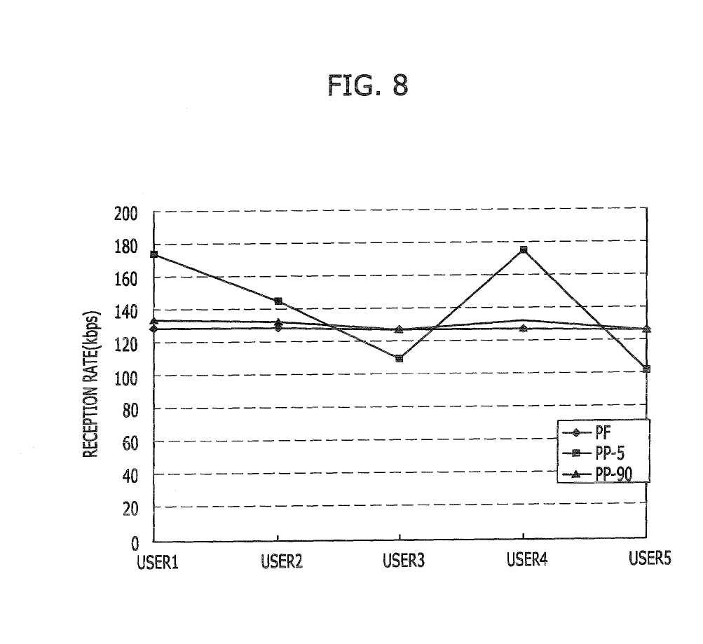

Referring to FIG. 8, if the value of A is 5, users may have a reception rate better than that of a typical proportional fairness scheduler or a reception rate worse than that of a typical proportional fairness scheduler, according to the environment. The typical proportional fairness scheduler makes entire reception rate uniformly based on the maximum fairness. On the contrary, if the value of A is 5, a receiver has a less chance if a corresponding receiver buffer has a higher probability of generating buffer overflow error in the present embodiment. Therefore, users having the higher probability of generating buffer overflow errors may have a reception rate worse than that of the typical proportional fairness scheduler.

Although some of users may have a reception rate worse than that of the typical proportional fairness scheduler, the overall reception rate is improved. Also, the packet scheduling method according to the present invention can guarantee about 90% of a reception rate of the typical proportional fairness scheduler although users do have bad channel states although packets are not continuously transmitted to one users having good channel state.

That is, if the value of A is 90, it is guaranteed to provide about the similar reception rate of the typical proportional fairness scheduler to users having bad channels and improves the reception rate of users having good channel environments although the overall reception rate is not great.

Therefore, if the packet scheduling method is applied with the A value of the typical proportional fairness scheduler set to 90, the packet scheduling method can improve the reception rate of users having good channel states without the reception rate of users having bad channel states degraded. That is, the reception rate is improved by reducing the waste of bandwidth due to buffer overflow error without fairness not provided.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to certain preferred embodiments, it will be apparent to those skilled in the art that various changes and modifications may be made without departing from the spirits and scope of the invention as defined in the following claims.

1. A method for packet scheduling in a selective hybrid automatic repeat request (HARQ) comprising the steps of:
increasing a priority of a receiver buffer after a packet is transmitted to the receiver;
receiving a feedback packet for the transmitted packet and determining whether the feedback packet is an ACK packet or a NACK packet;
lowering the priority of the receiver buffer if the feedback packet is an ACK packet;
determining whether the feedback packet is a NACK packet for initial transmission or the feedback packet is a NACK packet for retransmission if the feedback packet is the NACK packet, increasing the priority of the receiver buffer if the feedback packet is the NACK packet for the initial transmission, and lowering the priority of the receiver buffer if the feedback packet is the NACK packet for retransmission; and
scheduling packets after calculating a priority of each receiver buffer by performing the priority increasing step to the determining step for all of receivers.

2. The method of claim 1, wherein in the determining step, the priority of the receiver buffer is lowered if the feedback packet is an NACK packet for a packet retransmitted as many as maximum retransmit times.

3. The method of claim 1, wherein an initial value of the receiver buffer is 0.1, the priority of the receiver buffer increases as much as 10⁻⁵ when a packet is transmitted to the receiver, the priority of the receiver buffer decreases as much as 10⁻⁵ when an ACK packet for initial transmission and an NACK packet for retransmission are received, and the priority of the receiver buffer decreases or increases as much as 10⁻³ for any other cases.

4. The method of claim 3, wherein in the packet scheduling step, a packet is scheduled by applying the priority of the receiver buffer like an equation:
$$\frac{1}{log ( A + {BP}_{i} )} ,$$
wherein A denotes a real number larger than 1 and BPᵢ denotes a priority of a receiver buffer.

5. The method of claim 4, wherein an average gain value Gᵢ according to retransmission of HARQ is reflected to scheduling like an equation:
$$\frac{{G}_{i}}{log ( A + {BP}_{i} )} ,$$
wherein A denotes a real number larger than 1 and BPᵢ denotes a priority of a receiver buffer.

6. The method of claim 2, wherein an initial value of the receiver buffer is 0.1, the priority of the receiver buffer increases as much as 10⁻⁵ when a packet is transmitted to the receiver, the priority of the receiver buffer decreases as much as 10⁻⁵ when an ACK packet for initial transmission and an NACK packet for retransmission are received, and the priority of the receiver buffer decreases or increases as much as 10⁻³ for any other cases.
